(19) United States
(12) Patent Application Publication
(10) Pub. No.: US 2015/0348176 A1
(43) Pub. Date: Dec. 3, 2015

(54) SYSTEM AND METHOD FOR SELLING LAMPS

(71) Applicant: Zhongshan Baixun Lighting Co., Ltd., Zhongshan (CN)

(72) Inventor: Biwei SHI, Shenzhen (CN)

(73) Assignee: Zhongshan Baixun Lighting Co., Ltd., Zhongshan (CN)

(21) Appl. No.: 14/290,942

(22) Filed: May 29, 2014

(51) Int. Cl. G06Q 30/06

(52) U.S. Cl. CPC G06Q 30/0643; G06Q 30/0601

(57) ABSTRACT

A system for selling lamps, the system including: a server for storing lamp information; a display terminal for displaying the lamp information; a retail store; and a warehouse. The display terminal is connected to the server via a network. The display terminal is disposed in the retail store and operates to display the lamp information and receive the input of purchase data. The lamps are stored in the warehouse.

### BACKGROUND OF THE INVENTION

1. Field of the Invention

The invention relates to a system and a method for selling lamps.

2. Description of the Related Art

A typical method for selling lamps is employed in a retail store. As there are various types of lamps, a retail lamp store generally requires a display area of more than one thousand square meters. The operating cost of a retail lamp store mainly includes: store rent, display cost, and storage cost. The operating cost raises the price of the lamps, resulting in a high price thereof.

### SUMMARY OF THE INVENTION

In view of the above-described problems, it is one objective of the invention to provide a system and a method for selling lamps that are capable of significantly decreasing the sale cost.

To achieve the above objective, in accordance with one embodiment of the invention, there is provided a system for selling lamps, the system comprising: a server for storing lamp information; a display terminal for displaying the lamp information; a retail store; and a warehouse. The display terminal is connected to the server via a network. The display terminal is disposed in the retail store and operates to display the lamp information and receive the input of purchase data. The lamps are stored in the warehouse.

In a class of this embodiment, the lamp information comprises a picture, a video, or an animation of the lamps, and number of the lamps.

In a class of this embodiment, the display terminal is a computer comprising a displayer, an integrated machine, or a tablet PC comprising a touch screen.

In a class of this embodiment, the system further comprises a management system of distribution resource planning.

In accordance with another embodiment of the invention, there is provided a method for selling lamps, the method comprising:
1) collecting lamp information and storing the lamp information in a server, the lamp information comprising a picture, a video, or an animation of the lamps, and number of the lamps;
2) disposing a display terminal in a retail store, connecting the display terminal to the server via a network, and allowing the display terminal to display the lamp information;
3) displaying and demonstrating the lamps by a salesman by means of the display terminal;
4) selecting and paying for a desired lamp by a client whereby completing a sales order;
5) inputting the sales order into the display terminal by the salesman;
6) transmitting the sales order from the display terminal to the server, sending a delivery instruction by the server, and updating number information of the lamps by the server according to the sales order; and
7) delivering the lamp from a warehouse to the client according to the delivery instruction.

In a class of this embodiment, the retail store is more than one in number.

In a class of this embodiment, the display terminal is a computer comprising a displayer, an integrated machine, or a tablet PC comprising a touch screen.

In a class of this embodiment, the method further comprises employing a management system of distribution resource planning for management of lamp information collection, sales order, storage, purchasing, statistical analysis, and delivery.

Advantages of the invention are summarized as follows: the system and the method for selling lamps adopt a combination of sale in retail stores and virtual display for selling lamps. As the lamps are displayed on the display terminal, the room necessitated by the lamps for displaying is largely saved, thereby decreasing the area of the retail store and saving the cost of sales.

### DETAILED DESCRIPTION OF THE EMBODIMENTS

For further illustrating the invention, experiments detailing a system and a method for selling lamps are described below. It should be noted that the following examples are intended to describe and not to limit the invention.

A system for selling lamps comprises: a server for storing lamp information; a display terminal for displaying the lamp information; a retail store; and a warehouse. The display terminal is connected to the server via a network. The display terminal is disposed in the retail store and operates to display the lamp information and receive the input of purchase data. The lamps are stored in the warehouse. As the display terminal occupies a small room, it only requires a retail store of a small area for accommodating the display terminal and realizing the display and selling of the lamps by the display terminal The display terminal can also be arranged in a mall, such as a supermarket, so that just a ten square meter area is required to form a display and selling platform for the display and selling of the lamps.

The lamp information comprises pictures and videos that are capable of presenting appearance and effects of the lamps, and the number of the lamps. The information is lamp picture, lamp video, character, or a combination thereof. The lamp picture or lamp video is previously taken or prepared and uploaded to the server. The display terminals distributed in different regions are allowed to access the server via the network and to display the lamp picture or the lamp video for selection by customers. The display terminal comprises a display device and an input device. The display device operates to display the lamp information and allows the customer to feel the effect of the lamps. The input device is capable of inputting information of an order, thereby realizing on-line sale. The display terminal is a computer comprising a displayer, an integrated machine, or a tablet PC comprising touch screen.

The system for selling lamps further comprises a management system of distribution resource planning (DRP). The management system of DRP allows the sellers to have a quick response to the order, to supply the products in time, and to continuously replenish the inventory. The functions of the automatic supply of products and dynamic management of the inventory are highly intelligent; thereby avoiding terminal out-of-stock resulting from insufficient inventory, decreasing the occurrence of overstock of the inventory, and lowering the total inventory cost. By means of the DRP, the display terminal is able to real time inquiry the inventory of the lamps, that is, once the order is finished, the number of the inventory is decreased correspondingly.

A method for selling lamps comprises the following steps:

S1: collecting lamp information and storing the lamp information in a server, the lamp information comprising a picture, a video, or an animation of the lamps, and number of the lamps;

S2: disposing a display terminal in a retail store, connecting the display terminal to the server via a network, and allowing the display terminal to display the lamp information;

S3: displaying and demonstrating the lamps by a salesman by means of the display terminal;

S4: selecting and paying for a desired lamp by a client whereby completing a sales order;

S5: inputting the sales order into a management system of distribution resource planning through the display terminal by the salesman;

S6: transmitting the sales order from the display terminal to the server, sending a delivery instruction by the server, and updating number information of the lamps by the server according to the sales order; and

S7: delivering the lamp from a warehouse to the client according to the delivery instruction.

The method and the system for selling lamps employ a mode of on-line selling in a retail store, thereby having the following advantages:

1. Only a retail store of ten square meters is needed to arrange the display terminal, thus, the rent and the costing are largely saved, so that the purchase cost is lowered.

2. Customers are able to inquiry all species of the lamps, thereby overcoming the shortage of incapability of presenting all the lamps in a retail store because of the space restriction.

3. As the management system of DRP is adopted, the inventory of the lamps can be real-time inquired from each display terminal. Once one order is finished, the number of the inventory is decreased correspondingly, so that the efficiency of the whole supply chain is improved and the merchandise can be received in a short time, thereby enabling the customers to have a good shopping experience.

4. The sale status in each retail store can be fed back to the server by the display terminal in time, which is convenient for the management of the retail store, thereby being conducive to the spreading of the retail store.

5. The management system of DRP avoids the terminal out-of-stock resulting from insufficient storage as well as decreases the occurrence of overstock of the products, so that the total inventory cost is decreased.

6. The retail stores are also in charge of the lamp assembling and after-sale service in nearby regions, so that professional problems in lamp assembly and timeliness in after-sale service are properly solved.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A system for selling lamps, the system comprising:
a) a server for storing lamp information;
b) a display terminal for displaying the lamp information;
c) a retail store; and
d) a warehouse;
wherein
the display terminal is connected to the server via a network;
the display terminal is disposed in the retail store and operates to display the lamp information and receive the input of purchase data; and
the lamps are stored in the warehouse.

2. The system of claim 1, wherein the lamp information comprises a picture, a video, or an animation of the lamps, and number of the lamps.

3. The system of claim 1, wherein the display terminal is a computer comprising a displayer, an integrated machine, or a tablet PC comprising a touch screen.

4. The system of claim 1, further comprising a management system of distribution resource planning.

5. A method for selling lamps, comprising:
a) collecting lamp information and storing the lamp information in a server, the lamp information comprising a picture, a video, or an animation of the lamps, and number of the lamps;
b) disposing a display terminal in a retail store, connecting the display terminal to the server via a network, and allowing the display terminal to display the lamp information;
c) displaying and demonstrating the lamps by a salesman by means of the display terminal;
d) selecting and paying for a desired lamp by a client whereby completing a sales order;
e) inputting the sales order into the display terminal by the salesman;
f) transmitting the sales order from the display terminal to the server, sending a delivery instruction by the server, and updating number information of the lamps by the server according to the sales order; and
g) delivering the lamp from a warehouse to the client according to the delivery instruction.

6. The method of claim 5, wherein the retail store is more than one in number.

7. The method of claim 5, wherein the display terminal is a computer comprising a displayer, an integrated machine, or a tablet PC comprising a touch screen.

8. The method of claim 7, further comprising employing a management system of distribution resource planning for management of lamp information collection, sales order, storage, purchasing, statistical analysis, and delivery.
